(19) United States
(12) Patent Application Publication
(10) Pub. No.: US 2024/0083405 A1
(43) Pub. Date: Mar. 14, 2024

(54) Relay Valve Arrangement for a Trailer Brake System

(71) Applicant: Knorr-Bremse Systeme fuer Nutzfahrzeuge GmbH, Munich (DE)

(72) Inventors: Attila MAJLATH, Munich (DE); Laszlo KONCZ, Munich (DE); David JAKAB, Munich (DE)

(21) Appl. No.: 18/367,532

(22) Filed: Sep. 13, 2023

(30) Foreign Application Priority Data
Sep. 14, 2022 (GB) 2213451.4

(51) Int. Cl. B60T 15/02; B60T 13/68

(52) U.S. Cl. CPC B60T 15/027; B60T 13/683; B60T 2270/402

(57) ABSTRACT

A valve arrangement for a trailer brake module in a monoblock housing includes an input for a brake supply pressure, an input for a brake control pressure, and an output for supplying a brake pressure to braking devices on a trailer. The valve arrangement includes a relay valve, and includes control solenoids which are arranged substantially transversely to the direction of motion of the relay valve piston.

### CROSS REFERENCE TO RELATED APPLICATION

This application claims priority under 35 U.S.C. § 119 from GB Application No. 2213451.4, filed Sep. 14, 2022, the entire disclosure of which is herein expressly incorporated by reference.

### BACKGROUND AND SUMMARY OF THE INVENTION

The invention relates to a relay valve arrangement for a trailer brake system.

German patent publication no. DE 10 2016 116516 discloses a known type of trailer brake system relay valve in which the brake system includes a main valve unit; a pilot-control valve unit that is fluidically connected to the main valve unit; and a two part housing to accommodate at least the main valve unit and the pilot-control valve unit. The pilot-control valve unit includes a double solenoid unit and at least one valve device. The double solenoid unit is formed such that it can be populated with at least one valve device, and the double solenoid unit has at least two accommodating portions for accommodating valve devices and at least two solenoid devices for actuating the valve devices.

Chinese patent publication no. CN 108248591 discloses a further valve arrangement for a trailer brake system. The integrated EBS trailer valve comprises a valve body assembly, an upper cover assembly and a throttling piston assembly. A pressure sensor and an electromagnetic valve assembly are arranged in the trailer valve. In use the electromagnetic valve assembly can control the pressures in a trailer brake chamber and the trailer brake chamber pressure is monitored in real time through the pressure sensor.

International patent publication no. WO 2019/158498 A1 discloses a trailer control valve for a trailer of an utility vehicle, having at least one housing and at least one housing insert guided in the housing, and having at least one trailer control valve piston with a cylinder section and a collar section. The collar section of the trailer control valve piston is guided in the housing insert in at least a first position at least partially in a receptacle, wherein at least one non-return valve and at least one throttle bore are provided in the region of the receptacle.

In the known solutions the arrangement of relay piston unit is vertical and it is placed in divided (two parts) valve housing as this has proven to be the easiest and lowest cost assembly and also allows for easy maintenance of the valve and associated control electronics.

However, in the highly competitive field of trailer braking systems there is constant demand for reduction in size of the valve and for lower costs both in acquisition, operation and in lifetime maintenance of the brake system.

The present invention therefore seeks to provide a valve arrangement in a trailer brake module which enables the possibility of a smaller valve while addressing the lifetime costs of the valve.

According to the invention there is provided a valve arrangement for a trailer brake module, in which the module has an input for a brake supply pressure and an input for a brake control pressure and an output for supplying a brake pressure to braking devices on a trailer, wherein the valve arrangement includes a relay valve for applying and releasing the brake pressure to the braking devices, a load solenoid, and an exhaust solenoid and a back up solenoid. The solenoids are adapted to control pressure to a pilot port on the relay valve, wherein the brake pressure can be modulated. The output of the solenoids is arranged substantially transversely to the direction of motion of the relay valve.

In the invention the relay piston unit is arranged in horizontal position relative to the solenoids in the trailer brake module (TBM). This arrangement facilitates the use of a monoblock housing construction in contrast to the known two part constructions, which are inevitably prone to leak.

Preferably, the valve arrangement is arranged in a monoblock housing. Preferably, the output of the solenoids is arranged substantially perpendicularly to the direction of motion of a piston of the relay valve.

Preferably, the arrangement comprises a pressure transducer located on the output side of the relay valve, an output of the pressure transducer being able to modulate the output pressure of the relay valve. Preferably, the arrangement further comprises at least one solenoid, which solenoid can modulate the pressure on the output side of the relay valve. Preferably, the input for a brake supply pressure and an input for a brake control pressure and the output for supplying a brake pressure to braking devices on a trailer are disposed so that the relay valve can be inserted and removed from one side of the arrangement without removing the solenoids. Preferably, the input for a brake control pressure is arranged substantially perpendicularly to the direction of motion of the relay valve.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows schematically a first arrangement of a valve in accordance with the present invention.

FIG. 2 shows the pneumatic connections of a valve embodying the arrangements of FIG. 1.

FIG. 3 shows a cross section of the valve of FIG. 2.

FIG. 4 shows schematically a second arrangement of a valve in accordance with the present invention.

FIG. 5 shows a cut away of the valve of FIG. 4.

### DETAILED DESCRIPTION OF THE DRAWINGS

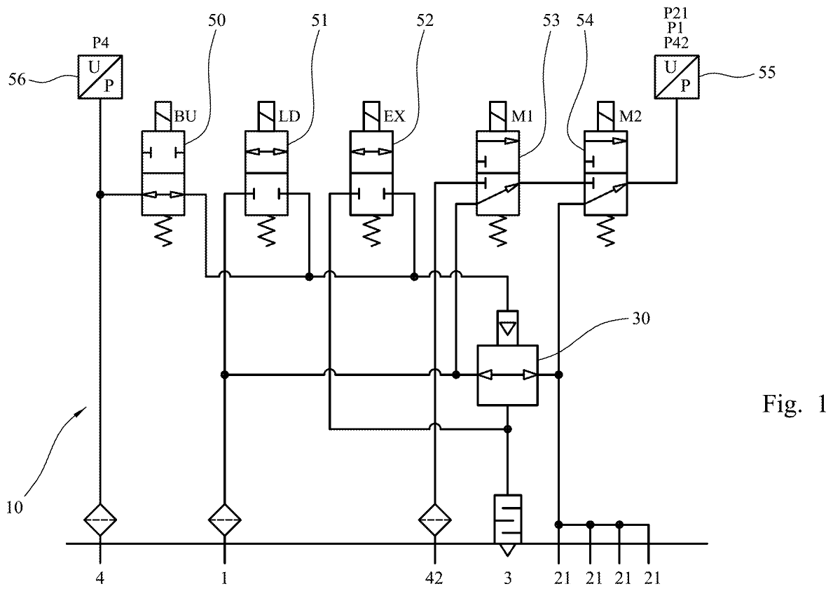

FIG. 1 shows schematically the arrangement of an example embodiment of the valve of the present invention, which includes a horizontally arranged relay piston unit 10. The valve arrangement is provided with pneumatic inputs for the main supply pressure 1, a control pressure 4 and an air bellow pressure 42. The valve arrangement is further provided with output ports for an exhaust 3 and the brake chambers 21. Four brake chambers are indicated by way of example as this is commercially common arrangement for a trailer brake system, but the invention would be applicable to trailer brake systems in which three axles (e.g., 6S4M) or only one axle (e.g., 2S1M) are braked.

The main supply pressure 1 is pneumatically connected to the input of the relay valve 30 as well as to the input of the load solenoid 51. The control pressure 4 is connected to the input of the back up solenoid 50. The relay valve 30 is provided with a first pneumatic output to the brake chambers 21 and a second pneumatic output to the exhaust 3 and to the input of the exhaust solenoid 52. The outputs of the load solenoid 50, back up solenoid 51 and exhaust solenoid 52 are connected to the pilot input of the relay valve 30.

A pressure control valve assembly being a combination of two 2/2 solenoid valves 53, 54, one of which valve 53 is normally open and the valve 54 is normally closed, controls the flow of air to the brake chambers. The solenoid valve 53 receives inputs from the air bellow pressure input 42 and the main supply pressure and the solenoid 54 receives an input from the output of the relay valve 30. The output of the solenoid 54 is connected to a pressure transducer 55, which measures the pressure out of the relay valve 30. The control pressure input is further connected to a second pressure transducer 56.

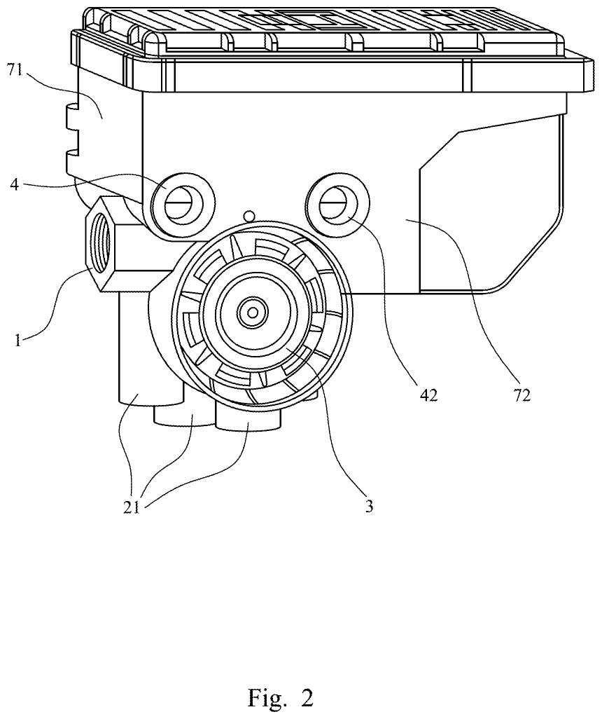

FIG. 2 shows the valve arrangement of the invention in a monoblock housing 70, with the main supply pressure port 1, the control pressure port 4 and the air bellow pressure port 42. The main pressure supply port 1 is arranged in a face 71 of the housing perpendicular to the face 72 with the inputs of the control pressure port 4 and air bellow pressure port 42. The outputs to the brake chambers 21 can be seen disposed perpendicularly to both of the faces 71 and 72. The relay valve exhaust is also arranged in the same face 72 as the control pressure port input 4 and air bellow input port 42.

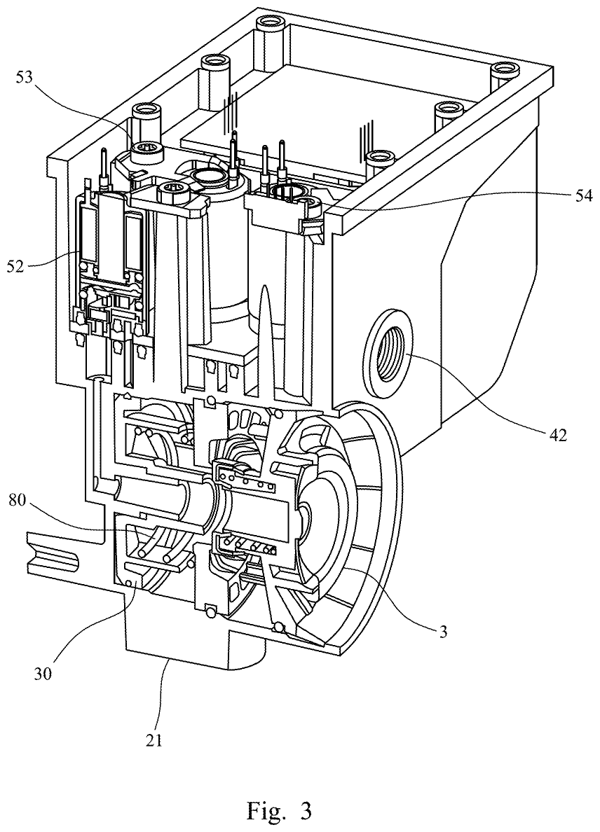

FIG. 3 shows a cross section through the valve body shown in FIG. 2. The relay valve 30 is arranged perpendicularly to the solenoids. The exhaust solenoid 52 and pressure control solenoids 53 and 54 are shown with the pneumatic connection of the solenoid 52 to the relay valve 30 visible. The relay valve is a piston type valve with O-rings 80 provided to reduce the friction between the piston and piston housing.

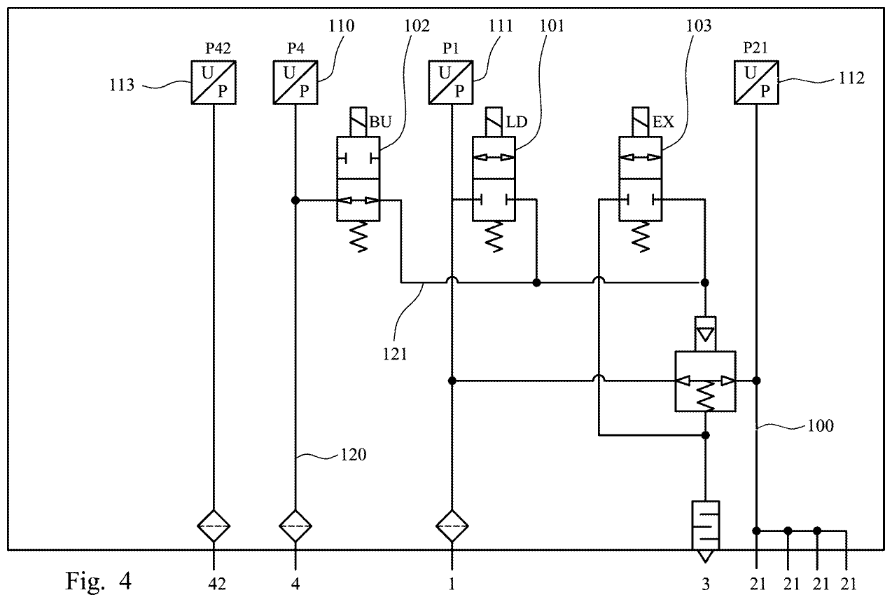

FIG. 4 shows an alternative arrangement to that of FIG. 1, which does not require multiplexing of the pressure control solenoids for measuring pressures and is therefore lower cost.

FIG. 4 shows schematically the arrangement of the valve comprising a horizontally arranged relay piston unit 100, which valve arrangement is provided with pneumatic inputs for the main supply pressure 1, a control pressure 4 and an air bellow pressure 42. The valve arrangement is further provided with output ports for an exhaust 3 and to the brake chambers 21. Four brake chambers are indicated by way of example as a commercially common arrangement for a trailer brake system, but the invention would be applicable to trailer brake systems in which three axles (e.g., 6S4M) or only one axle (e.g., 2S1M) are braked.

The main supply pressure 1 is pneumatically connected to the input of the relay valve 100 as well as to the input of the load solenoid 101. The control pressure 4 is connected to the input of the back up solenoid 102. The relay valve 100 is provided with a first pneumatic output to the brake chambers 21 and a second pneumatic output to the exhaust 3 and to the input of the exhaust solenoid 103. The outputs of the load solenoid 101, back up solenoid 102 and exhaust solenoid 103 are connected to the pilot input via path 121 of the relay valve 100.

A pressure transducer 110 is provided in the control pressure pneumatic path 120. A second pressure transducer 111 is provided in the supply pressure path. The pressure transducer 111 is shown on the input side to the back up solenoid 101 A third pressure transducer 112 is arranged on the output side of relay valve 100.

In the embodiment of FIG. 4 the air bellow pressure 42 is provided with a pressure transducer 113 and is pneumatically separate from the pneumatic circuit of the relay valve 100.

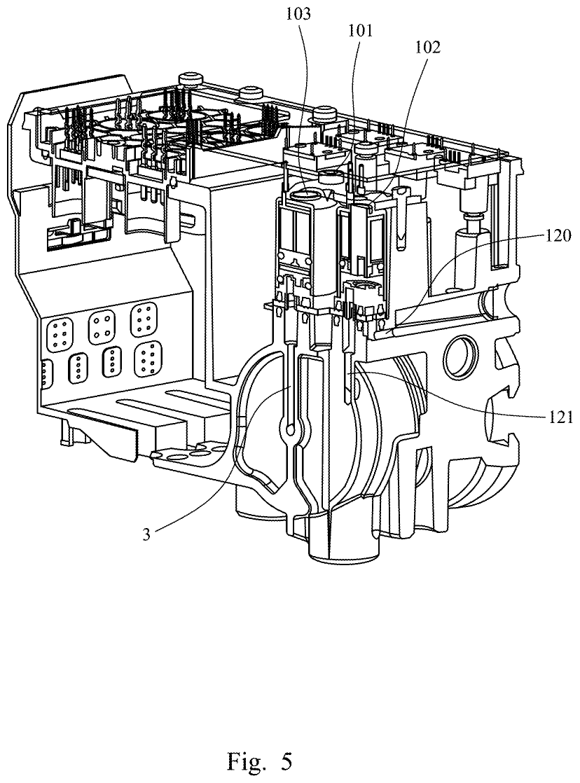

FIG. 5 shows a cut away of the valve arrangement of FIG. 4 showing the pneumatic path 120 from the control line 4 to the back up solenoid 102 and the control channel 121 to pilot the relay valve 100. Exhaust solenoid 103 controls the flow to the exhaust 3. The load solenoid is 101 disposed behind the solenoids 102 and 103. The control channel 121 and exhaust 3 are located on the side of the valve housing remote from the control pressure input 4.

The horizontal arrangement of the relay valve below the solenoids enables the assembly of the valve to be simplified as the relay valve can be assembled from one direction into a monoblock housing. The monoblock housing can also receive the solenoids without the need for a two stage assembly as in the known valves.

Whilst the relay valve has been described as being horizontal with respect the solenoids, the solenoids need not be substantially perpendicular to the direction of motion of the relay valve piston but can also be at an acute angle thereto in contrast to the conventional, substantially parallel to the direction of motion arrangement of solenoids in known braking relay valves.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

What is claimed is:

1. A valve arrangement for a trailer brake module, comprising:
a brake supply pressure input;
a brake control pressure input;
a brake pressure output configured to supply a brake pressure to braking devices on a trailer;
a relay valve configured to apply and release the brake pressure to the braking devices;
a load solenoid;
an exhaust solenoid; and
a back up solenoid
wherein the solenoids are configured to control pressure supply to a pilot port of the relay valve,
the brake pressure capable of being modulated, and
outputs of each the solenoids are arranged substantially transversely to a direction of motion of the relay valve.

2. A valve arrangement for a trailer brake module according to claim 1, wherein
the valve arrangement is arranged in a monoblock housing.

3. A valve arrangement according to claim 2, wherein
the outputs of each of the solenoids are arranged substantially perpendicularly to a direction of motion of a piston of the relay valve.

4. A valve arrangement according to claim 3, further comprising:
a pressure transducer located on an output side of the relay valve,
wherein an output of the pressure transducer is capable of modulating a output pressure of the relay valve.

5. A valve arrangement according to claim 4, further comprising:
at least one solenoid configured to modulate an output pressure of the relay valve.

6. A valve arrangement according to claim 1, wherein
the brake supply pressure input, the brake control pressure input, and the brake pressure output are disposed such that the relay valve is insertable and removable from a first side of the arrangement without removing the solenoids.

7. A valve arrangement according to claim 4, wherein
the brake supply pressure input, the brake control pressure input, and the brake pressure output are disposed such that the relay valve is insertable and removable from a first side of the arrangement without removing the solenoids.

8. A valve arrangement according to claim 5, wherein
the brake supply pressure input, the brake control pressure input, and the brake pressure output are disposed such that the relay valve is insertable and removable from a first side of the arrangement without removing the solenoids.

9. A valve arrangement according to claim 1, wherein
the brake control pressure input is arranged substantially perpendicularly to the direction of motion of the relay valve.

10. A valve arrangement according to claim 6, wherein
the brake control pressure input is arranged substantially perpendicularly to the direction of motion of the relay valve.
